(19) United States
(12) Patent Application Publication
(10) Pub. No.: US 2014/0134042 A1
(43) Pub. Date: May 15, 2014

(54) SILVER-FREE AND LEAD-FREE SOLDER COMPOSITION

(71) Applicant: Accurus Scientific Co., Ltd., Tainan City (TW)

(72) Inventor: Tien-Ting Chen, Tainan City (TW)

(73) Assignee: ACCURUS SCIENTIFIC CO., LTD., Tainan City (TW)

(21) Appl. No.: 14/010,370

(22) Filed: Aug. 26, 2013

(30) Foreign Application Priority Data
Nov. 12, 2012 (TW) 101142019

(51) Int. Cl. B23K 35/26

(52) U.S. Cl. CPC B23K 35/262
USPC 420/561

(57) ABSTRACT

A silver-free and lead-free solder composition includes: 2 wt % to 8 wt % of Bi, 0.1 wt % to 1.0 wt % of Cu, 0.01 wt % to 0.2 wt % of at least one of Ni, Fe, and Co, and the balance of Sn based on 100 wt % of the silver-free and lead-free solder composition.

### CROSS-REFERENCE TO RELATED APPLICATION

This application claims priority of Taiwanese Application No. 101142019, filed on Nov. 12, 2012.

### BACKGROUND OF THE INVENTION

1. Field of the Invention

This invention relates to a solder composition, more particularly to a silver-free and lead-free solder composition adapted to be used in soldering electronic components.

2. Description of the Related Art

In the prior art, a Sn—Pb alloy is usually used as a solder for electronic components. Owing to severe environmental pollution caused by lead and its compounds and increased environmental protection awareness, use of lead solders has been gradually forbidden in recent years. Hence, the lead solders are gradually being replaced by lead-free solders.

Among the lead-free solders, a Sn—Ag—Cu (SAC305) lead free solder and a Sn—Cu lead-free solder are used most widely, especially, the Sn—Ag—Cu (SAC305) solder. Due to an increase in the price of silver, the price of Sn—Ag—Cu alloy solder has become higher, thereby increasing the cost of an electronic component package using the same.

Accordingly, low-silver-content Sn—Ag—Cu solder or silver-free Sn—Cu solder is commonly used in the electronic packaging industry so as to reduce packaging costs. However, a tensile strength of the aforementioned low-silver-content or silver-free solder is inferior and wetting capability of the solder is insufficient. Thus, the soldering strength at the soldering joint between a solder bump and a substrate is relatively weak. Due to the insufficient wetting capability, the soldering bump may easily crack or peel off and thereby reduce bonding strength. Thus, electronic products may need to be reworked or scrapped.

Therefore, there is a need in the art to provide a solder composition that is free of Pb and Ag and that can overcome the drawbacks associated, with the prior art.

### SUMMARY OF THE INVENTION

The object of the present invention is to provide a silver-free and lead-free solder composition that can improve the tensile strength, bonding strength, and wetting capability, and that can reduce manufacturing costs.

According to this invention, there is provided a silver-free and lead-free solder composition that includes 2 wt % to 8 wt % of Bi, 0.1 wt % to 1.0 wt % of Cu, 0.01 wt % to 0.2 wt % of at least one of Ni, Fe, and Co, and the balance of Sn based on 100 wt % of the silver-free and lead-free solder composition.

### DETAILED DESCRIPTION OF THE PREFERRED EMBODIMENT

Other features and advantages of the present invention will become apparent in the following detailed description of the preferred embodiment.

The preferred embodiment of a silver-free and lead-free solder composition according to this invention includes 2 wt % to 8 wt % of Bi, 0.1 wt % to 1.0 wt % of Cu, 0.01 wt % to 0.2 wt % of at least one of Ni, Fe, and Co, and the balance of Sn based on 100 wt % of the silver-free and lead-free solder composition. In this invention, bismuth is used to replace silver so as to significantly reduce manufacturing costs. Moreover, the tensile strength and wetting capability are surprisingly increased, so that the solder composition of this invention provides a performance equal to or superior to that of the conventional Sn—Ag—Cu solder composition. In addition, a bonding strength could be increased by adding at least one of Ni, Fe, and Co in the solder composition of this invention.

Preferably, in this embodiment, the silver-free and lead-free solder composition further includes 0.003 wt % to 0.03 wt % of at least one of Ge, Ga, and P based on 100 wt % of the silver-free and lead-free solder composition. Therefore, an anti-oxidative activity of the solder composition in a wave-soldering process may be increased and generation of dross may be decreased.

### EXAMPLE

### Preparation of Solder Compositions for Examples 1 to 52 and Comparative Examples 1 to 39

Solder compositions for Examples 1 to 52 and Comparative Examples 1 to 3 9 were prepared by mixing components listed in Tables 1 to 4.

Effects of the present invention were proven by determining wetting capability (or solderability), a tensile strength, a bonding strength, and anti-oxidative activity.

### Evaluation Methods

1. Wetting capability was measured using a wetting balance analysis method. The solder composition of each of the examples and comparative examples was heated under 250° C. to form a molten solder bath. A copper pad that had a width of 10 mm, a length of 20 mm, and a thickness of 0.3 mm was applied with a soldering flux and excess of the soldering flux was drained off by standing the copper pad vertically, followed by dipping the copper pad into the molten solder bath. A wetting time of the molten solder composition, i.e., the time it took to allow the molten solder composition to completely adhere to the copper pad during the wetting process, was detected and calculated. The wetting capability of the solder composition was determined according to a standard as follows:

◯: wetting time<2 seconds;

Δ: 2 seconds≦wetting time<3 seconds; and

×: wetting time≧3 seconds.

2. The tensile strength was measured using a Vickers Pyramid Diamond Indenter with application of 50 gw load for 15 seconds. To measuring the tensile strength, a solder bump of the solder composition of each of the examples and comparative examples was formed on a copper pad by reflow soldering. The solder bump was cut to form a cutting surface and the measurement was conducted on the cutting surface using the Vickers Pyramid Diamond Indenter. An indentation formed on the cutting surface of the solder bump was measured so as to calculate the microhardness (Hv). The tensile strength was determined according to a standard as follows:

◯: microhardness>20 Hv;

Δ: 15 Hv<microhardness≦20 Hv; and

×: microhardness≦15 Hv.

3. The bonding strength was determined using zone shear bond test to detect a brittle fracture degree of a solder bump. The solder composition of each of the examples and comparative examples was reflowed with the copper pad, and a joint between a solder bump formed from the solder composition and the copper pad was then destroyed using a high speed bondtester. The bonding strength was evaluated according to a standard as follows:

◯: brittle fracture ratio<10%;

Δ: 10%≦brittle fracture ratio<15%; and

×: brittle fracture ratio≧15%.

4. Anti-oxidative activity was determined by heating the solder composition of each of Examples 38 to 54 for 30 minutes at 200° C. with ventilation of atmospheric air in an oven, and observing the change of brightness on a surface of a solder article formed from the solder composition. To be specific, the anti-oxidative activity was determined by the resistance to color change based on a standard as follows:

◯: the surface of the solder article having metal brightness;

Δ: the surface of the solder article exhibiting yellowish color; and

×: the surface of the solder article exhibiting yellow, blue, purple, or relatively dark colors.

TABLE 1

| | Component (wt %) | | | | | | | |
|---|---|---|---|---|---|---|---|---|
| | the balance of Sn | | | | | Wetting | Tensile | Bonding |
| | Cu | Bi | Ag | Ni | Ge | capability | strength | strength |
| Exp. 1 | 0.7 | 2.0 | 0 | 0.05 | 0 | Δ | ◯ | ◯ |
| Exp. 2 | 0.3 | 2.0 | 0 | 0.05 | 0.003 | ◯ | ◯ | ◯ |
| Exp. 3 | 0.7 | 2.0 | 0 | 0.05 | 0.003 | ◯ | ◯ | ◯ |
| Exp. 4 | 1.0 | 2.0 | 0 | 0.05 | 0.003 | ◯ | ◯ | ◯ |
| Exp. 5 | 0.7 | 3.0 | 0 | 0.05 | 0 | ◯ | ◯ | ◯ |
| Exp. 6 | 0.3 | 3.0 | 0 | 0.05 | 0.003 | ◯ | ◯ | ◯ |
| Exp. 7 | 0.7 | 3.0 | 0 | 0.05 | 0.003 | ◯ | ◯ | ◯ |
| Exp. 8 | 1.0 | 3.0 | 0 | 0.05 | 0.003 | ◯ | ◯ | ◯ |
| Exp. 9 | 0.7 | 8.0 | 0 | 0.05 | 0 | ◯ | ◯ | ◯ |
| Exp. 10 | 0.3 | 8.0 | 0 | 0.05 | 0.003 | ◯ | ◯ | ◯ |
| Exp. 11 | 0.7 | 8.0 | 0 | 0.05 | 0.003 | ◯ | ◯ | ◯ |
| Exp. 12 | 1.0 | 8.0 | 0 | 0.05 | 0.003 | ◯ | ◯ | ◯ |
| Comp. Exp. 1 | 0.7 | 0 | 0 | 0.05 | 0 | X | X | ◯ |
| Comp. Exp. 2 | 0.3 | 0 | 0 | 0.05 | 0.003 | X | X | ◯ |
| Comp. Exp. 3 | 0.7 | 0 | 0 | 0.05 | 0.003 | X | X | ◯ |
| Comp. Exp. 4 | 1.0 | 0 | 0 | 0.05 | 0.003 | X | X | ◯ |
| Comp. Exp. 5 | 0.7 | 1.0 | 0 | 0.05 | 0 | X | Δ | ◯ |
| Comp. Exp. 6 | 0.3 | 1.0 | 0 | 0.05 | 0.003 | Δ | Δ | ◯ |
| Comp. Exp. 7 | 0.7 | 1.0 | 0 | 0.05 | 0.003 | Δ | Δ | ◯ |
| Comp. Exp. 8 | 1.0 | 1.0 | 0 | 0.05 | 0.003 | Δ | Δ | ◯ |
| Comp. Exp. 9 | 0.7 | 10 | 0 | 0.05 | 0 | ◯ | ◯ | Δ |
| Comp. Exp. 10 | 0.3 | 10 | 0 | 0.05 | 0.003 | ◯ | ◯ | Δ |
| Comp. Exp. 11 | 0.7 | 0 | 1.0 | 0.05 | 0 | X | X | ◯ |
| Comp. Exp. 12 | 0.3 | 0 | 1.0 | 0.05 | 0.003 | X | X | ◯ |
| Comp. Exp. 13 | 0.7 | 0 | 1.0 | 0.05 | 0.003 | X | X | ◯ |
| Comp. Exp. 14 | 1.0 | 0 | 1.0 | 0.05 | 0.003 | X | X | ◯ |
| Comp. Exp. 15 | 0.7 | 0 | 2.0 | 0.05 | 0 | Δ | Δ | ◯ |
| Comp. Exp. 16 | 0.3 | 0 | 2.0 | 0.05 | 0.003 | Δ | Δ | ◯ |
| Comp. Exp. 17 | 0.7 | 0 | 2.0 | 0.05 | 0.003 | Δ | Δ | ◯ |
| Comp. Exp. 18 | 1.0 | 0 | 2.0 | 0.05 | 0.003 | Δ | Δ | ◯ |
| Comp. Exp. 19 | 0.7 | 0 | 3.0 | 0.05 | 0 | X | Δ | ◯ |
| Comp. Exp. 20 | 0.3 | 0 | 3.0 | 0.05 | 0.003 | Δ | Δ | ◯ |
| Comp. Exp. 21 | 0.7 | 0 | 8.0 | 0.05 | 0 | X | ◯ | X |
| Comp. Exp. 22 | 0.3 | 0 | 8.0 | 0.05 | 0.003 | X | ◯ | Δ |

Referring to Table 1, the results for Examples 1 to 12 show that, when Bi content ranges from 2 wt % to 8 wt %, the solder composition exhibits superior tensile strength and bonding strength, and higher wetting capability. As shown in Comparative Examples 1 to 8, when the solder composition contains no Bi or 1.0 wt % of Bi, the solder composition exhibits inferior tensile strength and wetting capability. As shown in Comparative Examples 9-10, when the solder composition contains 10 wt % of Bi, the wetting capability and the tensile strength are not further improved as compared with Examples 9-12. Moreover, because of high Bi content, the bonding strength is adversely affected and the melting point of the solder composition is undesirably reduced so that the alloy composition could, not be used.

On the other hand, as shown in Comparative Examples 11-14, when the solder composition contains no Bi but contains 1.0 wt % of Ag, it is extremely inferior in tensile strength and wetting capability. As shown in Comparative Examples 15-20, when the solder composition contains no Bi but contains 2.0 wt % or 3.0 wt % of Ag, the tensile strength and wetting capability are slightly improved but are still insufficient. As shown in Comparative Examples 21-22, when the solder composition contains no Bi but contains 8.0 wt % of Ag, the tensile strength was improved but the wetting capability was poor and not suitable for use due to the high melting point. Meanwhile, the bonding strength is also adversely affected.

Moreover, the properties of the solder compositions of Examples 1 to 4 (each having 2.0 wt % of Bi) are better than those of Comparative Examples 21-22 each having 8.0 wt % of Ag. Accordingly, as compared with the solder composition having Ag, the solder composition containing identical amount of Bi exhibits superior properties. According to this invention, by virtue of replacement of silver with bismuth and control of the Bi content to be within 2.0 wt % to 8.0 wt %, the tensile strength and the wetting capability could be improved and the manufacturing costs could be reduced so as to increase market competitiveness of the solder composition of this invention.

TABLE 2

| | Component (wt %) | | | | | | |
|---|---|---|---|---|---|---|---|
| | the balance of Sn | | | | Wetting | Tensile | Bonding |
| | Cu | Bi | Ni | Ge | capability | strength | strength |
| Exp. 13 | 0.1 | 2.0 | 0.05 | 0 | ◯ | ◯ | ◯ |
| Exp. 14 | 0.1 | 2.0 | 0.05 | 0.003 | ◯ | ◯ | ◯ |
| Exp. 15 | 0.3 | 2.0 | 0.05 | 0.003 | ◯ | ◯ | ◯ |
| Exp. 16 | 0.7 | 2.0 | 0.05 | 0 | ◯ | ◯ | ◯ |
| Exp. 17 | 0.7 | 2.0 | 0.05 | 0.003 | ◯ | ◯ | ◯ |
| Exp. 18 | 1.0 | 2.0 | 0.05 | 0 | ◯ | ◯ | ◯ |
| Exp. 19 | 1.0 | 2.0 | 0.05 | 0.003 | ◯ | ◯ | ◯ |
| Comp. Exp. 23 | 0 | 2.0 | 0.05 | 0.003 | X | ◯ | Δ |
| Comp. Exp. 24 | 0.05 | 2.0 | 0.05 | 0 | X | ◯ | Δ |
| Comp. Exp. 25 | 0.05 | 2.0 | 0.05 | 0.003 | X | ◯ | Δ |
| Comp. Exp. 26 | 1.2 | 2.0 | 0.05 | 0 | X | ◯ | Δ |
| Comp. Exp. 27 | 1.2 | 2.0 | 0.05 | 0.003 | Δ | ◯ | Δ |

Referring to Table 2, as shown in Examples 13-19, when Cu content of the solder composition ranges from 0.1 wt % to 1.0 wt %, the solder composition has superior wetting capability, tensile strength, and bonding strength.

As shown in Comparative Examples 23-25, when the solder composition contains no Cu or 0.05 wt % of Cu, the wetting capability and the bonding strength become inferior. As shown in Comparative Examples 26-27, when the solder composition contains 1.2 wt % of Cu, the melting point of the solder composition is raised, and the wetting capability and the bonding strength become lower because of the excess Cu content. Accordingly, when the Cu content ranges from 0.1 wt % to 1.0 wt %, the desired effect may be achieved.

TABLE 3

| | Component (wt %), | | | | | | | | |
|---|---|---|---|---|---|---|---|---|---|
| | the balance of Sn | | | | | | Wetting | Tensile | Bonding |
| | Cu | Bi | Ni | Co | Fe | Ge | capability | strength | strength |
| Exp. 20 | 0.7 | 2.0 | 0.01 | 0 | 0 | 0 | Δ | ◯ | Δ |
| Exp. 21 | 0.7 | 2.0 | 0 | 0.01 | 0 | 0 | Δ | ◯ | Δ |
| Exp. 22 | 0.7 | 2.0 | 0 | 0 | 0.01 | 0 | Δ | ◯ | Δ |
| Exp. 23 | 0.7 | 2.0 | 0.01 | 0 | 0 | 0.003 | ◯ | ◯ | Δ |
| Exp. 24 | 0.7 | 2.0 | 0 | 0.01 | 0 | 0.003 | ◯ | ◯ | Δ |
| Exp. 25 | 0.7 | 2.0 | 0 | 0 | 0.01 | 0.003 | ◯ | ◯ | Δ |
| Exp. 26 | 0.7 | 2.0 | 0.1 | 0 | 0 | 0 | Δ | ◯ | ◯ |
| Exp. 27 | 0.7 | 2.0 | 0 | 0.1 | 0 | 0 | Δ | ◯ | ◯ |
| Exp. 28 | 0.7 | 2.0 | 0 | 0 | 0.1 | 0 | Δ | ◯ | ◯ |
| Exp. 29 | 0.7 | 2.0 | 0.1 | 0 | 0 | 0.003 | ◯ | ◯ | ◯ |
| Exp. 30 | 0.7 | 2.0 | 0 | 0.1 | 0 | 0.003 | ◯ | ◯ | ◯ |
| Exp. 31 | 0.7 | 2.0 | 0 | 0 | 0.1 | 0.003 | ◯ | ◯ | ◯ |
| Exp. 32 | 0.7 | 2.0 | 0.2 | 0 | 0 | 0 | Δ | ◯ | ◯ |
| Exp. 33 | 0.7 | 2.0 | 0 | 0.2 | 0 | 0 | Δ | ◯ | ◯ |
| Exp. 34 | 0.7 | 2.0 | 0 | 0 | 0.2 | 0 | Δ | ◯ | ◯ |
| Exp. 35 | 0.7 | 2.0 | 0.2 | 0 | 0 | 0.003 | ◯ | ◯ | ◯ |
| Exp. 36 | 0.7 | 2.0 | 0 | 0.2 | 0 | 0.003 | ◯ | ◯ | ◯ |
| Exp. 37 | 0.7 | 2.0 | 0 | 0 | 0.2 | 0.003 | ◯ | ◯ | ◯ |
| Comp. Exp. 28 | 0.7 | 2.0 | 0.005 | 0 | 0 | 0 | Δ | ◯ | X |
| Comp. Exp. 29 | 0.7 | 2.0 | 0 | 0.005 | 0 | 0 | Δ | ◯ | X |
| Comp. Exp. 30 | 0.7 | 2.0 | 0 | 0 | 0.005 | 0 | Δ | ◯ | X |
| Comp. Exp. 31 | 0.7 | 2.0 | 0.005 | 0 | 0 | 0.003 | ◯ | ◯ | X |
| Comp. Exp. 32 | 0.7 | 2.0 | 0 | 0.005 | 0 | 0.003 | ◯ | ◯ | X |
| Comp. Exp. 33 | 0.7 | 2.0 | 0 | 0 | 0.005 | 0.003 | ◯ | ◯ | X |
| Comp. Exp. 34 | 0.7 | 2.0 | 0.3 | 0 | 0 | 0 | Δ | ◯ | X |
| Comp. Exp. 35 | 0.7 | 2.0 | 0 | 0.3 | 0 | 0 | Δ | ◯ | X |
| Comp. Exp. 36 | 0.7 | 2.0 | 0 | 0 | 0.3 | 0 | Δ | ◯ | X |
| Comp. Exp. 37 | 0.7 | 2.0 | 0.3 | 0 | 0 | 0.003 | ◯ | ◯ | X |
| Comp. Exp. 38 | 0.7 | 2.0 | 0 | 0.3 | 0 | 0.003 | ◯ | ◯ | X |
| Comp. Exp. 39 | 0.7 | 2.0 | 0 | 0 | 0.3 | 0.003 | ◯ | ◯ | X |

Referring to Table 3, as shown in Examples 20 to 25, when the content of at least one of Ni, Fe or Co was 0.01 wt %, the solder composition has superior tensile strength and sufficient wetting capability and bonding strength. As shown in Examples 26 to 37, when the content of at least one of the Ni, Fe, or Co was 0.1 wt % or 0.2 wt %, the bonding strength was further improved. Addition of Ni, Fe or Co element would inhibit generation of a brittle Cu₃Sn metallic phase, and would facilitate generation of a non-brittle Cu₆Sn₈ metallic phase. Therefore, the bonding strength between the solder bump and the copper pad may be significantly increased.

As shown in Comparative Examples 28 to 33, when the content of at least one of the Ni, Fe, or Co is 0.005 wt %, the content of Ni, Fe, or Co is insufficient to inhibit generation of the brittle Cu₃Sn metallic phase, thereby reducing bonding strength. As shown in Comparative Examples 34 to 39, when the content of at least one of Ni, Fe, or Co is 0.3 wt %, the bonding strength is also reduced due to a loose structure attributed to the excess Ni, Fe, or Co.

TABLE 4

| | Component (wt %), | | | | | | | | | | Anti-oxid |
|---|---|---|---|---|---|---|---|---|---|---|---|
| | the balance of Sn | | | | | | | Wetting | Tensile | Bonding | ative |
| | Cu | Bi | Ni | Fe | Ge | Ga | P | capability | strength | strength | activity |
| Exp. 38 | 0.7 | 2.0 | 0.05 | 0 | 0 | 0 | 0 | Δ | ◯ | ◯ | X |
| Exp. 39 | 0.7 | 2.0 | 0.05 | 0 | 0 | 0 | 0.001 | ◯ | ◯ | ◯ | Δ |
| Exp. 40 | 0.7 | 2.0 | 0.05 | 0 | 0 | 0.001 | 0 | Δ | ◯ | ◯ | X |
| Exp. 41 | 0.7 | 2.0 | 0.05 | 0 | 0.001 | 0 | 0 | Δ | ◯ | ◯ | X |
| Exp. 42 | 0.7 | 2.0 | 0 | 0.05 | 0 | 0 | 0.003 | ◯ | ◯ | ◯ | ◯ |
| Exp. 43 | 0.7 | 2.0 | 0.05 | 0 | 0 | 0.003 | 0 | ◯ | ◯ | ◯ | ◯ |
| Exp. 44 | 0.7 | 2.0 | 0.05 | 0 | 0.003 | 0 | 0 | ◯ | ◯ | ◯ | ◯ |
| Exp. 45 | 0.7 | 2.0 | 0 | 0.05 | 0 | 0 | 0.015 | ◯ | ◯ | ◯ | ◯ |
| Exp. 46 | 0.7 | 2.0 | 0.05 | 0 | 0 | 0.015 | 0 | ◯ | ◯ | ◯ | ◯ |
| Exp. 47 | 0.7 | 2.0 | 0.05 | 0 | 0.015 | 0 | 0 | ◯ | ◯ | ◯ | ◯ |
| Exp. 48 | 0.7 | 2.0 | 0 | 0.05 | 0 | 0 | 0.03 | ◯ | ◯ | ◯ | ◯ |
| Exp. 49 | 0.7 | 2.0 | 0.05 | 0 | 0 | 0.03 | 0 | ◯ | ◯ | ◯ | ◯ |
| Exp. 50 | 0.7 | 2.0 | 0.05 | 0 | 0.03 | 0 | 0 | ◯ | ◯ | ◯ | ◯ |
| Exp. 51 | 0.7 | 2.0 | 0.05 | 0 | 0 | 0.05 | 0 | ◯ | ◯ | ◯ | ◯ |
| Exp. 52 | 0.7 | 2.0 | 0.05 | 0 | 0.05 | 0 | 0 | ◯ | ◯ | ◯ | ◯ |

Referring to Table 4, as shown in Examples 42 to 50, when the content of at least one of Ge, P, or Ga ranges from 0.003 wt % to 0.03 wt %, the solder composition has superior wetting capability, tensile strength, bonding strength and anti-oxidative activity. This is because the Ge, P, or Ga element could form an anti-oxidative layer on the surface of the solder article so as to isolate environmental oxygen and improve anti-oxidative activity of the solder composition.

As shown in Examples 38 to 41, when the solder composition contains no or 0.001 wt % of at least one of Ge, P, or Ga, the anti-oxidative activity becomes poor. As shown in Examples 51 to 52, when the content of Ge or Ga is 0.05 wt %, the effects are identical to Examples 42-50, i.e., the wetting capability, the tensile strength, the bonding strength, and the anti-oxidative activity are not further improved and the material consumption is increased, thereby resulting in an increase in manufacturing costs.

Accordingly, when the content of at least one of Ge, P, or Ga ranges from 0.003 wt % to 0.03 wt %, the anti-oxidative activity effect may be achieved.

To sum up, in this invention, with replacement of expensive silver with bismuth, the manufacturing costs could be reduced while the tensile strength and the wetting capability could be improved so as to increase the market competitiveness of the solder composition of this invention. At the same time, the bonding strength and the wetting capability of the solder composition could be improved by controlling the content of copper to be within 0.1 wt % to 1.0 wt %. The bonding strength could also be increased by controlling the content of at least one of Ni, Fe, or Co to be within 0.01 wt % to 0.2 wt %. Additionally, the anti-oxidative activity of the solder composition could be improved by adding 0.003 wt % to 0.03 wt % of at least one of Ge, P, or Ga. Consequently, the silver-free and lead-free solder composition according this invention has the aforesaid superior properties and reduced costs.

While the present invention has been described in connection with what are considered the most practical and the preferred embodiments, it is understood that this invention is not limited to the disclosed embodiments but is intended to cover various arrangements included within the spirit and scope of the broadest interpretation and equivalent arrangements.

What is claimed is:

1. A silver-free and lead-free solder composition, comprising: 2 wt % to 8 wt % of Bi, 0.1 wt % to 1.0 wt % of Cu, 0.01 wt % to 0.2 wt % of at least one of Ni, Fe, and Co, and the balance of Sn based on 100 wt % of said silver-free and lead-free solder composition.

2. The silver-free and lead-free solder composition as claimed in claim 1, further comprising 0.003 wt % to 0.03 wt % of at least one of Ge, Ga, and p based on 100 wt % of said silver-free and lead-free solder composition.
